(19) United States
(12) Patent Application Publication
(10) Pub. No.: US 2007/0204070 A1
(43) Pub. Date: Aug. 30, 2007

(54) USB device, USB system and recording medium storing USB control program

(75) Inventor: Satoshi Imai, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KYOCERA MITA CORPORATION, Osaka (JP)

(21) Appl. No.: 11/362,195

(22) Filed: Feb. 27, 2006

(51) Int. Cl. G06F 3/00

(52) U.S. Cl. 710/8

(57) ABSTRACT

The present invention seeks to eliminate the necessity of reinstalling a driver and various types of settings whenever a USB device which is the same type of USB device previously used is plugged into a host computer, or is plugged to another port. Thus, when a USB device 1 is connected to a host computer 6, the USB device, in response to a transmission request from the host computer 6, returns an identification number common to other USB devices along with maker identification information and product identification information. Moreover, when the USB device 1 is connected to the host computer 6 to which other USB devices of the same type as the USB device 1 are connected, the USB device 1 returns the common identification number, and thereafter returns an identification number different from the common identification number in response to a request from the host computer 6, thereby enabling the host computer 6 to identify and recognize the subsequently connected device or devices.

### BACKGROUND OF THE INVENTION

1. Field of the Invention

The present invention relates to an USB device which is connected to a host computer via a USB (Universal Serial Bus), a USB system, and a recording medium which stores a USB control program.

2. Description of the Related Art

Conventionally, when multiple USB devices of the same type are connected via USB ports of a host computer, a particular identification number is assigned to each USB device, and the identification number is conveyed to the host computer upon connection thereto, leading the host computer to distinguish the respective USB devices from each other.

For example, according to Japanese Laid-Open Patent Publication. No. 2001-144769 (hereinafter, “Patent Document 1”), respective USB devices are provided with a device identification number setting apparatus which includes a dip switch and a nonvolatile ROM, and a certain identification number is assigned to the USB devices, such that when the respective USB devices are plugged in, the host computer receives the device identification number along with information identifying the maker and the product, and communicates with the USB device based on such information.

Moreover, according to Japanese Laid-Open Patent Publication No. 2003-316720 (hereinafter, “Patent Document 2”), the serial number of a component pertaining to respective USB devices is used to identify the same, and when the respective USB devices are plugged in, the host computer receives such identification number, and communicates with the particular USB device based on such identification number.

However, the USB device of the abovementioned prior art suffered from a flaw, in that a particular USB device which is similar to another USB device that has been previously used with a single host computer would be recognized by the host computer as another product, thereby necessitating the need to re-install a driver to carry out various types of setting, resulting in additional labor.

On the other hand, USB devices can be configured in such manner that their respective identification numbers are not returned to the host computer, such that USB devices which are actually similar products are recognized as such, and the host computer will not request for driver installation again to establish various types of settings every time another but similar USB device is inserted as a substitute. Despite this, however, when a similar USB device is plugged into a different port, the host computer still recognizes the device as a different product, and requires installation of a driver and various types of settings.

### SUMMARY OF THE INVENTION

The present invention therefore seeks to address the foregoing problems by eliminating the necessity of re-installation of a driver and various settings when another product but similar to a USB device previously used is plugged in, or when a previously used USB device is plugged into a different port.

Accordingly, the first aspect of the present invention provides for a USB device with retaining means for retaining maker identification information, product type identification information, and an identification number commonly shared with other USB devices, and a USB controller which returns such common identification number to other USB devices along with corresponding maker and product identification information when it is connected to a host computer in response to a transmission request therefrom.

The second aspect of the present invention provides for a USB device according to the first aspect thereof, where, upon being connected to the host computer, the USB controller, in response to a request from the host computer, returns the abovementioned common identification number of the USB devices of the same type already connected thereto, and thereafter returns an identification number different from such common identification number.

The third aspect of the present invention provides for a USB system comprising a USB device and a host computer to which the USB device is connected, where the USB device includes retaining means for retaining maker identification information, product type identification information, and an identification number commonly shared with other USB devices, and a USB controller which returns such common identification number to other USB devices along with corresponding maker and product type identification information when they are connected to a host computer in response to a transmission request from the host computer, where the host computer includes a USB port that manages communication with the USB device based upon such maker identification information, product identification information, and the identification number received from the USB device.

In addition, the fourth aspect of the present invention provides for a recording medium storing program, where the recording medium stores a USB control program that causes a USB controller constituting a USB device to return the identification number common to other USB devices along with maker identification information and product type identification information, when the USB device is connected to a host computer, in response to a transmission request therefrom.

Further the fifth aspect of the present invention provides for a recording medium according to the fourth aspect thereof, where the recording medium stores a USB control program that causes the USB controller to return the common identification number of USB devices of the same type already connected to the host computer when a USB device is connected thereto, and thereafter carry out the process of returning an identification number different from such common identification number, in response to a request from the host computer.

### BRIEF DESCRIPTION OF THE DRAWINGS

FIG. 1 is a block diagram showing the schematic configuration of a USB system.

FIG. 2 is a diagram showing the flow process when a USB device is connected.

FIG. 3 is a diagram showing the flow process when a second USB device is connected.

### DETAILED DESCRIPTION OF THE PREFERRED EMBODIMENTS

A detailed description will now be given of an embodiment of the present invention in relation to the drawings.

### Embodiment

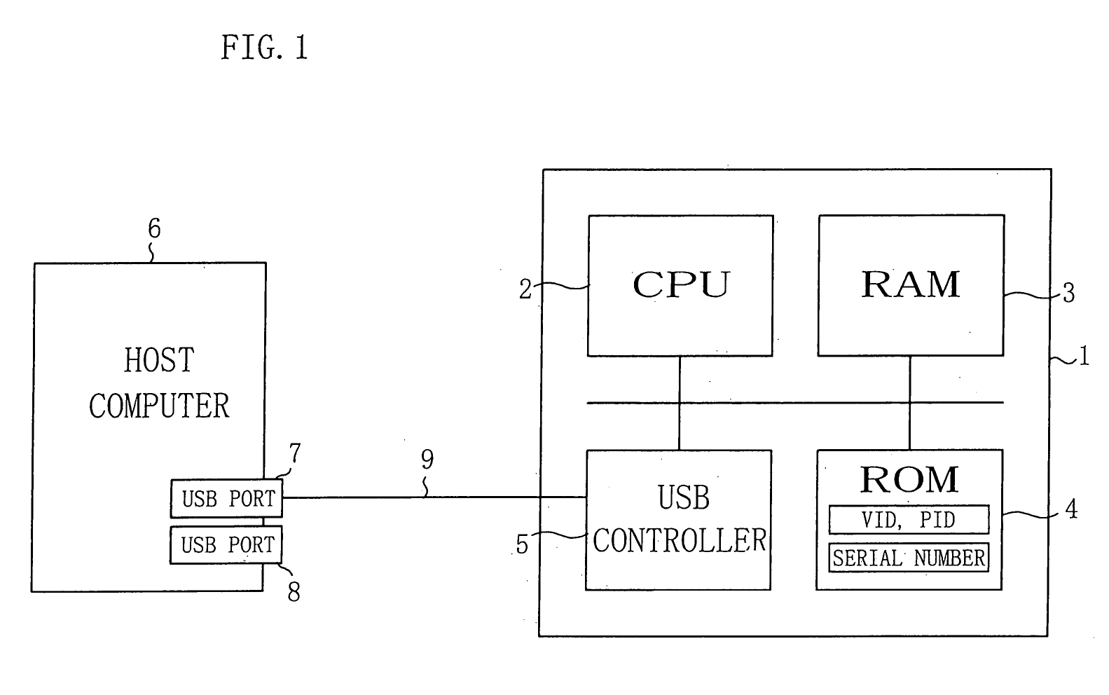

FIG. 1 is a block diagram showing the schematic configuration of a USB system, in which a USB device 1 is connected to a host computer 6 via a USB controller 5 and a USB cable 9. The USB device 1, which is provided with a CPU 2, a RAM 3, a ROM 4, and the like, communicates with the host computer 6 via the USB controller 5, the USB cable 9, and the USB port 7 (or 8), and carries out a predetermined control operation based on an instruction received from the host computer 6.

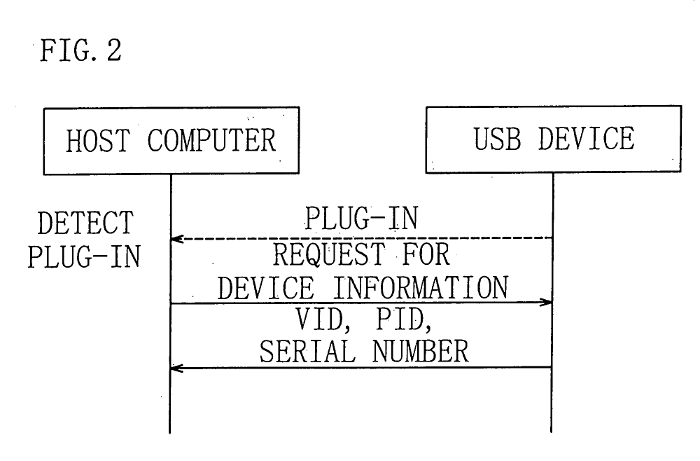

The ROM 4 retains maker identification information VID, product type identification information PID, and an identification number common to all products such as “0000000000”. When the USB cable 9 of the USB device 1 is plugged into the USB port 7 of the host computer 6, the host computer 6 detects the plug-in, and requests the USB device 1 for device information such as maker identification information VID, the product type identification information PID, and the like as a process flow shown in FIG. 2. Upon receiving the request, the USB device 1 transmits to the host computer 6 the maker identification information VID, the product type identification information PID, and the identification number common to all the products such as “0000000000”.

The host computer 6 loads a driver specific to the USB device 1 identified by the maker identification information VID, the product type identification information PID, and the identification number, and further receives various types of setting data, if necessary, to create an operating system as one of its functions, thereby establishing a communication connection with the USB device 1.

It is then assumed that when a predetermined process that takes place during connection of the USB device 1 is completed, the USB device 1 is disconnected from the host computer 6 and another USB device which is similar in type to the USB device 1 is plugged into the USB port 7 (or 8) of the host computer 6. In this case, the host computer 6 also receives maker identification information VID, the product type identification information PID, and the common identification number from the USB device. On this occasion, since the VID, PID, and identification number are identical to those previously received from the USB device 1, the host computer 6 determines that the same USB device is connected. Since the driver and the like corresponding to USB devices have already been built in, the host computer 6 can simply establish communication connection with such subsequently installed USB device.

By transmitting the identification number common to all USB device products in this way to another USB device which is identical to the USB device already previously plugged into the host computer 6 and used, it will not be necessary to re-install the driver and various types of setting. In this manner, it becomes possible and convenient for users of portable personal computers and USB devices who commute between office and home to use USB devices of the same type by simply plugging them in any USB port.

However, when two or more USB devices of the same type and having the same identification number are simultaneously connected to the host computer 6, a problem arises because the host computer 6 cannot distinguish the two USB devices from one another.

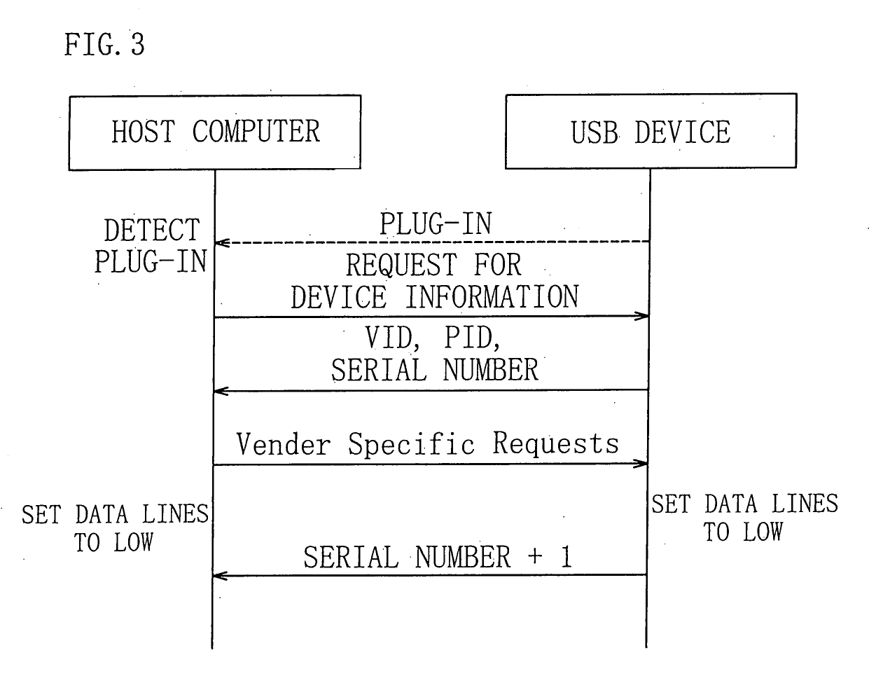

To address this problem, if a USB device which is connected to the host computer 6 returns maker identification information VID, product type identification information PID, and identification number similar to those of a USB device presently connected to the host computer 6, the host computer 6 issues a specify maker request to the subsequently connected USB device as shown in FIG. 3. Upon receiving such request, the USB device rewrites the identification number to the next value “0000000001”, and sets the two DATA lines (D+, D−) to low level to disconnect them once from the computer and then reconnect them to the host computer 6, thereby causing the host computer 6 to recognize the second USB device as a new one with a different identification number.

On this occasion, the RAM 3, which has a volatile memory, is made to retain the rewritten identification number, but the rewritten identification number disappears when the second USB device is reconnected as a first USB device on another occasion, and such USB device then returns the number “0000000000”, which is retained in the ROM 4 as its identification number, and can thus be recognized as the first device.

Although the example which uses the specify maker request is described according to the embodiment described above, the present invention is not limited to this example, and can be realized by means of an instruction which changes a predetermined identification number, or an instruction which indicates that the device being connected has an identification number already assigned to a previously connected device.

In particular, according to this specify maker request method, while a command to change the serial number is defined in advance by means of the specify maker request and the serial number is changed by issuing the command by means of control transfer, another method may be employed, where the command to change the serial number may be defined by means of a control command such as the “prescribe” command or the PJL command, which is transmitted by means of bulk transfer. Usually, although USB devices transfer a control command by means of control transfer and transfer data by means of bulk transfer, the former method is generally used. However, transfer may still be carried out by the latter method.

A USB device, a USB system, and a recording medium storing a USB control program according to the present invention provide the following effects.

Thus, in the first aspect of the present invention, since a USB device is configured to return an identification number common to other USB devices along with maker identification information and product type identification information upon being connected to a host computer in response to a transmission request from the host computer, it would not be necessary to carry out re-installation of a driver and various types of settings even if a subsequent USB device which is similar in type to that of a USB device previously used is plugged into the host computer, or a USB device previously used is plugged into another port.

Moreover, in the second aspect of the present invention, since the USB device according to the first aspect is configured so as to return an identification number which is different from the abovementioned common identification number upon a request from the host computer when the USB device is connected to the host computer to which other similar USB devices are connected, the host computer is capable of identifying and distinguishing the USB device in question even if two or more USB devices are connected to the host computer at the same time.

In addition, in the third aspect of the present invention, since a USB system is configured in such manner that it can return an identification number common to other USB devices along with maker and product type identification information once connected to a host computer in response to a transmission request from the host computer, and the host computer manages communication with the USB device based upon such maker and product type identification information and the identification number received from the USB device, it would not be necessary to carry out re-installation of a driver and various types of settings even if a subsequent USB device which is similar in type to that of a USB device previously used is plugged into the host computer, or a USB device previously used is plugged into another port.

Further, in the fourth aspect of the present invention, a recording medium storing a USB control program is configured in such manner that the USB control program causes a USB device, upon being connected to a host computer, to return an identification number common to other USB devices along with maker and product type identification information in response to a transmission request from the host computer, such that it would not be necessary to carry out re-installation of a driver and various types of settings even if a subsequent USB device which is similar in type to that of a USB device previously used is plugged into the host computer, or a

Further still, in the fifth aspect of the present invention, since the USB control program causes the USB device to again return an identification number which is different from the abovementioned common identification number upon a request made by the host computer when the USB device is connected to the host computer to which other similar USB devices are connected, such that the host computer is capable of identifying the respective devices even if two or more USB devices of the same type are connected to the host computer at the same time.

What is claimed is:

1. A USB device comprising:
retaining means that retains maker identification information, product identification information, and an identification number common to other USB devices; and
a USB controller that, upon being connected to a host computer, in response to a transmission request from the host computer, returns the identification number common to other USB devices along with maker identification information and product identification information.

2. The USB device according to claim 1, wherein, upon being connected to the host computer to which other USB devices of the same type are connected, the USB controller returns the said common identification number to the host computer, and thereafter returns an identification number different from the common identification number in response to a request from the host computer.

3. A USB system comprising:
a USB device; and
a host computer to which the USB device is connected, wherein:
the USB device comprises retaining means that retains maker identification information, product identification information, and an identification number common to other USB devices, and a USB controller that, upon being connected to the host computer, in response to a transmission request from the host computer, returns the identification number common to other USB devices along with maker identification information and product identification information; and
the host computer comprises a USB port that manages communication with the USB device based on the maker identification information, product identification information, and identification number received from the USB device.

4. A recording medium storing a USB control program, wherein the USB control program causes a USB controller constituting a USB device, which, upon being connected to a host computer, returns an identification number common to other USB devices along with maker identification information and product identification information, in response to a transmission request from the host computer.

5. The recording medium according to claim 4, wherein the USB control program causes the USB controller to return the common identification number when the USB device is connected to the host computer, to which other USB devices of the same type are connected, and thereafter carry out a process of returning an identification number different from the common identification number, in response to a request from the host computer.
